(19) United States
(12) Patent Application Publication
(10) Pub. No.: US 2011/0066443 A1
(43) Pub. Date: Mar. 17, 2011

(54) Methods, system, and apparatus for enhancing child safety

(76) Inventor: John Raskob, Tucson, AZ (US)

(21) Appl. No.: 12/924,759

(22) Filed: Oct. 5, 2010

Related U.S. Application Data
(63) Continuation-in-part of application No. 12/009,685, filed on Jan. 22, 2008.

(51) Int. Cl. G06Q 99/00

(52) U.S. Cl. 705/1.1

(57) ABSTRACT

This invention includes a method for providing enhanced child safety for a child including subscribing to a child safety service provider, receiving child safety material from the child safety service provider, submitting child identifying material relating to the child to the child safety service provider, associating the child identifying material with a unique identifier, determining that the child is missing, retrieving the child identifying material utilizing the unique identifier, and disseminating the child identifying material to one or more persons conducting a search for the missing child wherein it is preferable for at least one of the persons conducting the search to be a private investigator.

This application is a continuation-in-part of the non-provisional patent application Ser. No. 12/009,685 filed on Jan. 22, 2008.

### FIELD OF THE INVENTION

The present invention relates generally to the field of improving child safety, and is more particularly related to systems, methods, and apparatus for preventing the loss and/or abduction of children and methods for remediation therefor.

### DESCRIPTION OF THE PRIOR ART

It is estimated that for every 1 million children in the United States, over ten thousand will become missing yearly and about 40% of those are never found. In fact, nearly two million children are reported missing to law enforcement agencies throughout the United States every year. Even with the enhanced interest that media stories have created, the danger to children from loss and/or abduction continues to present a serious risk to our children and our communities. While some school and community programs have been put in place to try to educate parents and the public, these “band-aid” measures have not decreased the abduction statistics, in fact, it is estimated that the number of children missing since 1982 has increased by over 482%. Also, these programs have not improved the ability of parents and/or law enforcement agencies to gain an advantage in preventing child losses or abductions and enhancing the likelihood of safe and rapid return in the event that such loss or abduction occurs. Even though legislation was passed to put in place the “Amber Alert” system, the quality of the alerts vary from community to community, and less than 1% of the lost, missing, or runaway child cases in America actually qualify to use it. Worse yet, when children are lost or abducted, parents are often stricken with panic deciding what to do first and, in the precious time immediately after the loss becomes known, unprepared parents and law enforcement agencies are often challenged to obtain important information that is crucial in conducting an effective investigation and rescue of endangered children. FBI statistics estimate that about 44% of abducted children are dead within one hour, 75% are dead within three hours, and nearly 100% are dead within 24 hours. Therefore, it would be an advance in the art for a service to be offered to parents and/or guardians whereby a unified and comprehensive approach to preventing child loss and or abduction is presented and improvements made to the likelihood and speed at which lost or abducted children are returned to their rightful parents or guardians.

### SUMMARY

This invention includes a method for providing enhanced child safety for a child including subscribing to a child safety service provider, receiving child safety material from the child safety service provider, submitting child identifying material relating to the child to the child safety service provider, associating the child identifying material with a unique identifier, determining that the child is missing, retrieving the child identifying material utilizing the unique identifier, and disseminating the child identifying material to one or more persons conducting a search for the missing child wherein it is preferable for at least one of the persons conducting the search to be a private investigator. Optional embodiments of the invention may including using a confidential unique identifier, providing one or more pictures, providing one or more videos, or providing a physical description of the child to the child safety service provider. The parent or caregiver of the child may utilize the child safety material to educating the parent/caregiver and/or the child as to the dangers of child abduction or other causes of children becoming lost. Periodic reminders may be sent from the child safety service provider to the parent/caregiver requesting current child identifying material. A pre-established database may be used and consulted should the child become missing to determine an optimum information strategy.

### BRIEF DESCRIPTION OF THE DRAWINGS

FIG. 1 is a flow chart illustrating the first steps in the process of providing enhanced child safety.

FIG. 2 is a flow chart continuing the method of FIG. 1.

### DESCRIPTION OF THE INVENTION

This invention provides for a comprehensive system that stresses prevention of child loss or abduction through enhanced security and education, coupled with an organized, effective recovery system in the event that a loss or abduction occurs.

In one implementation of the present invention, once a parent or guardian becomes interested in utilizing services related to the present invention, they subscribe to a service providing materials regarding prevention, and receive a one-stop contact for reporting a lost child and bringing to bear all the community resources possible to effect a rapid and safe recovery of the missing child. The subscription provides child loss prevention and recovery services in exchange for a periodically charged fee.

An embodiment of the present invention addresses the presentation and review of an array of high-quality educational materials designed to make it easier for participating parents and/or guardians to address the important issues of child safety with their children in the privacy of their own homes. Both parents and children alike may benefit from understanding the threats that exist to children, and accordingly understanding how to avoid becoming a victim of one of those threats. In one implementation, after parents review a safety guide with their children, the children are provided educational and entertaining materials for reinforcement of the safety learning experience. Such learning materials may include, but not by way of limitation, posters with key safety points, coloring books having safety-related messages, video games that present risky scenarios and characters successfully dealing with threats, and a program rewarding children for discussing with their parents possible threats they may have seen in the community around them.

In one embodiment, the following information may be provided to subscribing parents/guardians: “Guide To Safer Children”: this guide will help a participating parent learn ways to reduce their children's risks of becoming lost or missing; “Play It Safe Coloring Book”: this full-size coloring & activity book makes learning about safety fun for children of all ages; a “Safety Seven” poster specially designed to help participant's children learn and remember the Seven Rules for safety. These items have enough information to educate a child without overwhelming or scaring them. Additional information provided includes, a “How To Video Your Child” step-by-step directions guide showing the proper way to shoot an effective identification video; “What to Do If Your Child Is Missing” pamphlet describing what to do when a child is missing and how to go about providing notification in the time-critical period directly following the abduction or loss; “Secret Identification Code Labels” providing privacy by linking a unique identifier, such as an alpha-numeric string, to the video taken for the child, whereby only the participant knows the number that links the profile information such as the video to the particular participant's child; a pre-addressed video mailer to assist in sending video of any format of the participant's child to the service provider; “Missing Child Report” that assists participants with compiling the information needed by both the police and the service provider to help the participating parent and/or guarding search for the missing child; a “Wallet/Purse Response Packet” that provides ready access to information that activates the service provider to assist with child recovery even when the participating parent or guardian is away from home (and in one implementation, virtual contact cards are disseminated electronically to the participant for inclusion in the participant's contact management software); and a “Complete Instructions” guide detailing what a subscribing/participating parent or guardian needs to know to get the most out of the information provided.

Participating parents and guardians also benefit from periodic reinforcement of child safety information. For example, child safety information may include periodic updates on current methods used by child abductors. Therefore, in one embodiment, participating parents and guardians also receive a periodical newsletter that gives them topics to discuss with their children and keep them educated on the “tricks” that child predators use. In one implementation, the parents and guardians may log into a website to review safety videos with their children, and/or to review educational materials more appropriately addressed to adults, such as how to work with children to keep them interested and motivated in safety issues. The periodical publications also remind participating parents to talk with their children and provides topics to talk about. In one implementation, the periodical also provides a pull-out page for the participant's child to learn by doing puzzles and coloring.

When a child does become missing, the ability to positively identify that child becomes critical. In one implementation, a video registration service provides one of the most effective types of positive identification available. In one embodiment, the video information is converted to digital form and stored on a secure server for rapid distribution in the event that a loss and/or abduction occurs. Unlike a still photograph, a properly prepared Identification Video can give the authorities and concerned citizens so much more to go on when searching for a missing child. Familiarity with characteristics of voice, manner, and motion can greatly improve the likelihood that someone may remember having seen the child. Such a recollection could provide the all-important clue that leads to a reunion of child and family. In another implementation, as part of the instructions furnished to the participating parent and/or guardian, a method is described to prepare or collect an appropriate item bearing the scent of the child that is to be protected. Once the scent bearing “marker” is submitted to the service provider, the scent marker of the child can be delivered to local law enforcement the same day of a loss or abduction, where, if necessary, bloodhounds can be used to track the child.

Updates to the participating child profile are regularly scheduled and reminders automatically sent to participating parents to notify them that the child recovery profile information should be updated to reflect changes in the child's appearance over time. In one implementation, the video and picture of the participant's child are stored for two years, and participants automatically receive a new kit at 24 months providing instructions to update the picture and video. In one implementation, participants are encouraged to contact the service provider to update the participant's child's profile in the event that the child significantly changes outward appearance, such as by dramatically changing hair styles; and in one embodiment, digitized videos and/or pictures of the participant's child may be directly uploaded to the service provider through a secure website link, allowing the service provider to update the provider's secure identity database, and in one embodiment, security precautions may be taken by establishing a Virtual Private Network between the service provider and the subscriber/participant prior to data upload. In another implementation, time-linked records of images and pictures are maintained by the service provider and may be provided to forensic investigators to better construct “aged” depictions of the participant's children to assist in the event that a recent photo or video is unavailable. In another embodiment, to preserve privacy and security of the child's identity, the service provider links the participant's video and other data to the participant only through a unique, confidential identifier, and the child's name is not known by the service provider until linked to the unique identifier by the subscribing participant (such as in the event that the participant's child was reported missing). In yet another implementation, the child's uploaded information is first encrypted through a symmetric public key encryption system, so that the identity of the child is uniquely and securely linked to the participant/subscriber.

Rapid and effective action in the hours immediately following the loss or abduction is crucial in successfully recovering children unharmed. Yet during this time, the panic that sets into parents and guardians impairs their ability to make fast and effective decisions in notifying authorities, raising public awareness, and furnishing crucial information to law enforcement agencies. In one implementation, participating parents and/or guardians are provided in advance with information regarding how to report a missing child, and steps to take if a child is missing. This information, in another embodiment, is always available on the child loss and recovery service provider's website so that panicked parents may have ready access if they lose their reporting information.

In the past, while rewards have been offered in information leading to recovery of missing children, the difficulty in obtaining reward funds often delays the announcement of a reward to such an extent that it is of limited benefit in enhancing the likelihood of safe recovery. In one implementation, upon determining that a participating parent/guardian has submitted a notice of a missing child, a reward is immediately offered. In one embodiment, a proprietary database maintained by the service provider contains access information for an array of pre-screened private investigators worldwide. Through proper selection of an investigation resource from this database, the service provider can notify a private investigator to immediately proceed to the scene of the abduction to assist with recovery efforts in the most crucial time following the abduction, for instance, within an hour in most locations served by the service provider. In one implementation, a minimum amount of private investigator services is contracted by the prevention and recovery service provider, such as a minimum of $2500 of services, per case, to help find a missing subscriber's child. This capability gives the participating parents/guardians “peace of mind” that experienced resources are coming to their aid in addition to the resources of law enforcement agencies.

Effective distribution of information is also a goal of the present invention. At least two factors contribute to effectiveness: the speed and adequacy of the dissemination of child recovery information, and the selection of the best venues for dissemination of the child recovery information. To this end, in one implementation, the present invention provides a single “one stop, one call” source for immediate assistance in distributing information that is vital to the recovery effort. When a registered child becomes missing, the ready availability of recovery information allows the immediate contact with agencies providing local and far-reaching assistance to the child's family and the law enforcement agencies involved.

In one implementation, upon being notified of a child's disappearance, the pre-stored information is forwarded to the investigating police department, and assistance is offered by duplicating video and posters bearing the child's image and distributing them to any or all destinations included in a database of law enforcement agencies, missing children's service organizations, and national news media contacts. In one implementation, a link to law enforcement agencies that trigger an Amber Alert is immediately exercised, increasing the likelihood that the public can provide crucial tips and recovery information to law enforcement. In one implementation, a database of millions of concerned citizens nationwide is notified of the child's disappearance by both electronic and telephonic means, whereby the aid of motivated members of the public can be added to the law enforcement and subscriber's efforts to find the missing child.

In another implementation, after receiving notice of the missing child, videos, digital video files, digital photos, and/or posters to any additional destinations the investigating authorities may request, including immediate distribution to local law enforcement vehicles such as police cars, along with an announcement of a significant reward amount, such as $50,000 for information leading to the arrest and conviction of those responsible for the child's disappearance. In yet another embodiment, upon receiving notice from a participating subscriber that the subscriber's child is missing, duplication of child recovery profile materials begins, and a distribution plan is enacted to sent the materials to the identified assistance and law enforcement agencies.

In one embodiment, digitized copies of photographs, videos, reward, and recovery information are disseminated to addresses previously identified in a database maintained by the service provider. In one implementation, for example, a press release with accompanying reward, photo, and video information is sent to news outlets that were identified as appropriate markets for distribution of recovery data. As the search for the child is expanded, such as by law enforcement notifying the participants of a likely location to be searched, the distribution of materials may be adjusted and new information may be sent to the new search venue (such as in the case when a child has been abducted by a noncustodial parent, and the non-custodial parent's address becomes known after investigation). In one implementation, links to the service provider's website are provided, wherein members of the media, law enforcement agencies, or the community may view information related to the missing child, such as full-color, high resolution missing child posters, pictures, or videos. This allows a missing child's information to be accessed by law enforcement agencies and others across America (and the World) within minutes.

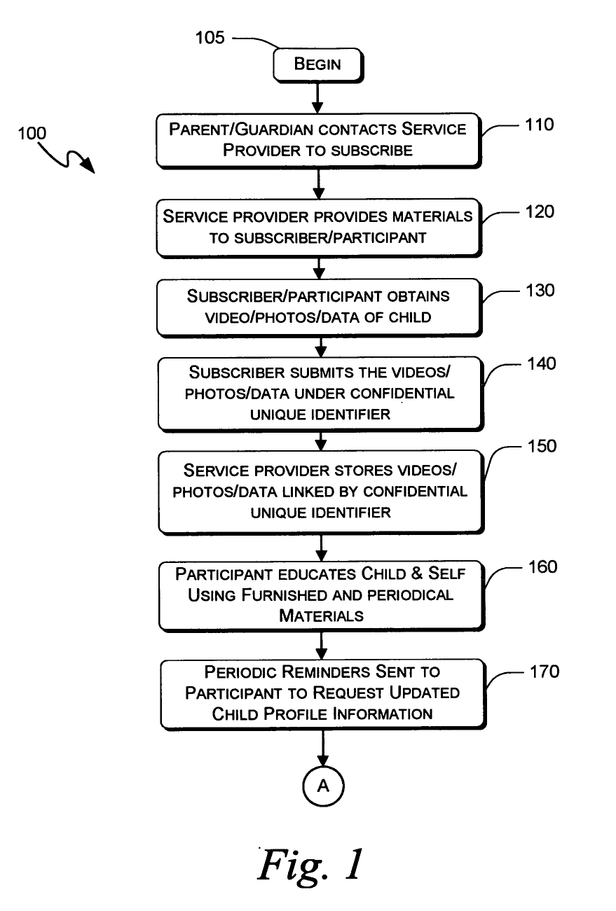

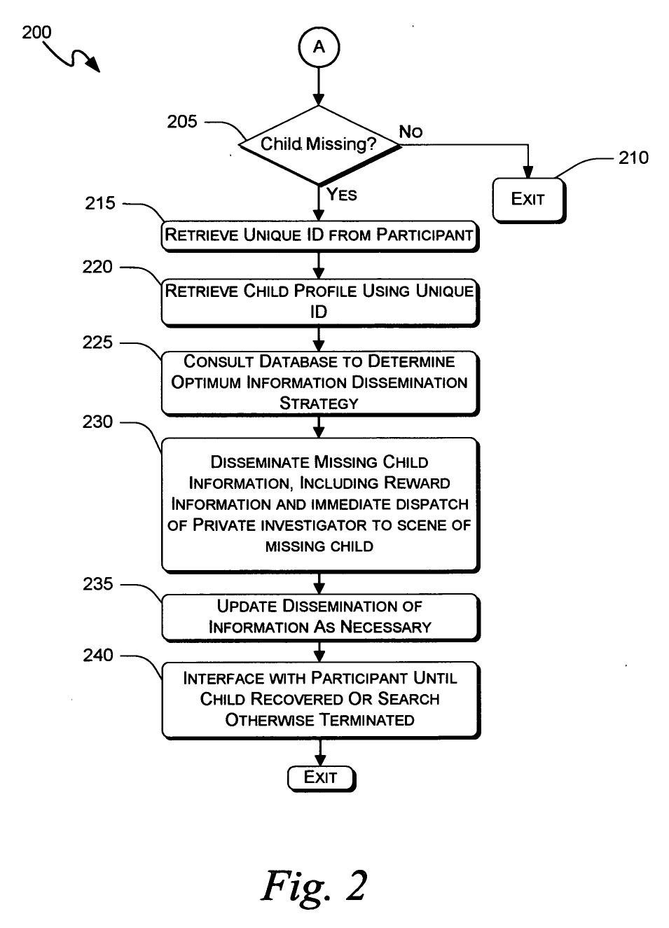

FIGS. 1 and 2 depict implementations providing participant subscription, child data information aggregation, and steps to respond in the event of a child is reported missing. The method begins in step 105 and continues with a parent or guardian contact a service provider to subscribe the their services in step 110. The service provider provides materials to the subscriber/participant in step 120. The subscriber/participant then obtains identifying media such as video, photos, or other data in step 130 and submits this information, using a unique identifier, to the service provider in step 140. In one embodiment of the invention, the parent, guardian, or caretaker creates a five (5) minute video of the child(ren) in any video format, then marks the video with the unique identifier and submits the video in a pre-addressed video mailer. The service provider stores the identifying media linked to the confidential unique identifier in step 150. Upon receiving the video, it is transformed using a computer or a digital processing device into a digital file, optionally with a standardized format, and stored on a digital storage device such as a computer hard drive or tape drive. In one embodiment of the invention, thirty seconds of the five (5) minute video is selected, transformed utilizing a computer or digital processing device into a digital file having a standardized format, and stored on the digital storage device along with a still picture digitally sampled from the five (5) minute video. Both the thirty second digital file and the digital still picture may be marked with the unique identifier.

In step 160, the subscriber/participant educates himself and the child using material provided by the service provider. The service provider sent periodic reminders to the subscriber/participant in step 170 to request updated child profile information.

Should the child never go missing, the method terminates in step 210, with the exception of the periodic reminders alluded to in step 170. If, however, the child should go missing, as determined in the decision point 205 of the flowcharted method, the subscriber/participant provides, in step 215, the confidential unique identifier obtained in step 120 to the service provider who, in turn, retrieves the most current child profile information using the confidential unique identifier in step 220. In one embodiment of the invention, the thirty second digital file and the digital still picture are retrieved from the digital storage device and (a) distributed Nationwide in a computerized database to over 16,000 agencies which include, but are not limited to, law enforcement and media contacts; (b) are transformed into a downloadable page on an internet web-site which includes a full color missing child poster offering a $50,000 reward and contact information; (c) placed on an internet web-site for viewing; (d) transmitted to a full time Private Investigator which is dispatched to the scene of the child's disappearance; and (e) transmitted Nationwide to the “National Child Watch Team,” a database of concerned parents who can help locate the child. Because the video received from the parent, guardian, or caretaker has been transformed from a source video format, which could be one a plethora available to parents today, into a digital file that may, optionally, be stored using a standardized digital video file format, the information (video) of the child is readily available to a multitude of agencies and persons that might be helpful in locating the child with almost no waiting period or qualification. This is distinctive from the current state of the art as current missing child programs traditionally require the child and circumstances to meet certain conditions or qualification, such as the Amber Alert system.

In step 225, the service provider consults a pre-established database to determine the optimum information dissemination strategy and missing child information including child profile and reward information are disseminated in step 230 and one or more private investigators are dispatched to the last know location of the missing child. As the investigation proceeds, the information which may be disseminated is updated in step 235 and the service provider continues to interface/communicate with the subscriber/participant until the child is found in step 240 of the search is otherwise terminated.

The present invention may be embodied in other specific forms without departing from its spirit or essential characteristics. Some or all of the indicated steps are optional and different embodiments of the invention may be created using different combination of the indicated steps. Likewise, the order of the steps is not to be considered limiting on the invention. The described embodiments are to be considered in all respects only as illustrative and not restrictive. All changes which come within the meaning and range of equivalency of the claims are to be embraced within their scope.

1. A method of providing enhanced child safety for a child, comprising the steps of:
subscribing to a child safety service provider;
receiving child safety material from the child safety service provider;
submitting child identifying material relating to the child to the child safety service provider;
transforming the submitted child identifying material into a standardized digital video file;
associating the standardized digital video file with a unique identifier;
storing the standardized digital video file and the unique identifier;
determining that the child is missing;
retrieving the standardized digital video file utilizing the unique identifier; and
immediately disseminating the standardized digital video file to at least one person conducting a search for the indicated child, without qualification.

2. The method of claim 1, wherein the child identifying material includes a photograph of the child.

3. The method of claim 1, wherein the child identifying material includes a video of the child.

4. The method of claim 1, wherein the child identifying material includes a physical description of the child.

5. The method of claim 1, wherein the unique identifier is confidential.

6. The method of claim 1, wherein the unique identifier is an alpha-numeric string.

7. The method of claim 1, wherein the at least one person conducting a search for the indicated child includes a private investigator.

8. The method of claim 1, further comprising the step of educating the child using the child safety material.

9. The method of claim 1, further comprising the step of receiving periodic reminders to update the child identifying material.

10. The method of claim 1, further comprising the step of receiving periodic updates on current methods used by child abductors.

11. The method of claim 1, further comprising the step of placing the standardized digital video file in a pre-established database.

12. The method of claim 11, wherein the pre-established database is accessible by law enforcement agencies.

13. The method of claim 11, wherein the pre-established database is accessible by media outlets.

14. The method of claim 1, further comprising the step of placing the standardized digital video file on an internet webpage.

15. The method of claim 14, wherein the internet webpage includes reward and contact information.
